(19) United States
(12) Patent Application Publication
(10) Pub. No.: US 2025/0124062 A1
(43) Pub. Date: Apr. 17, 2025

(54) INFORMATION PROCESSING APPARATUS, CONTENT GENERATION SYSTEM, AND CONTROL METHOD

(71) Applicant: NEC Corporation, Tokyo (JP)

(72) Inventors: Masahiro SERIZAWA, Tokyo (JP); Shinnosuke Nishimoto, Tokyo (JP); Akio Yoshioka, Tokyo (JP); Masahiro Iwadare, Tokyo (JP)

(73) Assignee: NEC Corporation, Tokyo (JP)

(21) Appl. No.: 18/908,969

(22) Filed: Oct. 8, 2024

(30) Foreign Application Priority Data
Oct. 16, 2023 (JP) 2023-178450

(51) Int. Cl. G06F 16/332; G06F 16/338

(52) U.S. Cl. CPC G06F 16/3329; G06F 16/338

(57) ABSTRACT

High-quality content generated with use of machine-learned generative model is presented to a user. An information processing apparatus includes: a first generating section for causing a first generative model to generate first content; a second generating section for using the first content to cause a second generative model to generate second content; and a presenting section for presenting the second content to a user. This information processing apparatus even makes it possible to optimize the second content to be presented to a user.

### CROSS REFERENCE TO RELATED APPLICATIONS

This application is based upon and claims the benefit of priority from Japanese Patent Application No. 2023-178450 filed on Oct. 16, 2023, the disclosure of which is incorporated herein in its entirety by reference.

### TECHNICAL FIELD

The present disclosure relates to an information processing apparatus, a content generation system, and a control method.

### BACKGROUND ART

Techniques are known for generating content with use of a machine-learned generative model (also referred to as a generative artificial intelligence (AI)). For example, Patent Literature 1 below discloses a terminal for generating, via an automatically responding AI, a response to what a user says and notifying the user of the response.

### CITATION LIST

### Patent Literature

### Patent Literature 1

Japanese Patent Application Publication Tokukai No. 2019-91387

### SUMMARY OF INVENTION

### Technical Problem

The techniques for generating content with use of a generative model including the automatically responding AI disclosed in Patent Literature 1 are susceptible to improvement in terms of improving the quality of the generated content. An example object of the present disclosure is to provide a technique for making it possible to present, to a user, high-quality content generated with use of a generative model.

It should be noted that the criterion by which to evaluate the “quality” is any criterion, and is not particularly limited. For example, content having high degree of adaptability for a user may be taken as the high-quality content, or content constituting information which is highly correct and specialized may be taken as the high-quality content.

### Solution to Problem

An information processing apparatus in accordance with an example aspect of the present disclosure includes at least one processor, and the at least one processor carries out: a first generating process of causing a first generative model to generate first content; a second generating process of using the first content to cause a second generative model to generate second content; and a presenting process of presenting the second content to a user.

A content generation system in accordance with an example aspect of the present disclosure includes: a first apparatus including a first generative model; and a second apparatus including a second generative model, and the first apparatus is configured to input a first query to the first generative model to cause the first generative model to generate first content, and also transmit to the second apparatus the first content generated, and the second apparatus is configured to use the first content received from the first apparatus, to cause the second generative model to generate second content.

A control method in accordance with an example aspect of the present disclosure includes: at least one processor causing a first generative model to generate first content; the at least one processor using the first content to cause a second generative model to generate second content; and the at least one processor presenting the second content to a user.

### Advantageous Effects of Invention

An example aspect of the present disclosure provides an example advantage of making it possible to present, to a user, high-quality content generated with use of a generative model.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of a control method in accordance with the present disclosure.

FIG. 3 is a block diagram illustrating a configuration of content generation system in accordance with the present disclosure.

FIG. 4 is a representation of the outline of another content generation system in accordance with the present disclosure.

FIG. 5 is a block diagram illustrating a configuration of a terminal in accordance with the present disclosure.

FIG. 6 is a block diagram illustrating a configuration of a generation apparatus in accordance with the present disclosure.

FIG. 7 is a representation of example content generation in the content generation system illustrated in FIG. 4.

FIG. 8 is a representation of an example display screen displayed by the terminal illustrated in FIG. 5.

FIG. 9 is a flowchart illustrating a flow of processes carried out by the terminal illustrated in FIG. 5.

FIG. 10 is a representation of another example content generation in the content generation system illustrated in FIG. 4.

FIG. 11 is a representation of the outline of still another content generation system in accordance with the present disclosure.

FIG. 12 is a representation of example content generation in the content generation system illustrated in FIG. 11.

FIG. 13 is a flowchart illustrating a flow of processes carried out by the terminal illustrated in FIG. 11.

FIG. 14 is a block diagram illustrating a configuration of a computer which functions as the information processing apparatus in accordance with the present disclosure.

### DESCRIPTION OF EMBODIMENTS

The following description will discuss example embodiments of the present invention. However, the present invention is not limited to the example embodiments described below, but can be altered by a skilled person in the art within the scope of the claims. For example, any embodiment derived by appropriately combining technical means adopted in differing example embodiments described below can be within the scope of the present invention. Further, any embodiment derived by appropriately omitting one or more of the technical means adopted in differing example embodiments described below can be within the scope of the present invention. Furthermore, the advantage mentioned in each of the example embodiments described below is an example advantage expected in that example embodiment, and does not define the extension of the present invention. That is, any embodiment which does not provide the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is basic to each of the example embodiments which will be described later. It should be noted that the applicability of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

### Configuration of Information Processing Apparatus 1

The configuration of an information processing apparatus 1 will be described below with reference to FIG. 1. FIG. 1 is a block diagram illustrating the configuration of the information processing apparatus 1. The information processing apparatus 1 includes a first generating section 101, a second generating section 102, and a presenting section 103, as illustrated in FIG. 1.

The first generating section 101 causes a first generative model 111 to generate first content. The first generative model 111 is a generative model having been trained so as to generate content in accordance with an inputted query. As described above, the first generative model 111 is used for generating the first content. For example, the first generating section 101 may generate the first content, by inputting to the first generative model 111 a query entered by a user. Note that the “query” means an order or an instruction for generating content. The “query” in the following description can therefore be replaced with a “generation order”, a “generation instruction”, or a “prompt”.

The first content only needs to be usable in generating the second content. For example, the first generating section 101 may generate, as the first content, a query used for the generation of the second content. In this case, the second generating section 102 can generate the second content by inputting the generated query to a second generative model 112.

As the first generative model 111, a model in accordance with the first content intended to be generated may be used. For example, in a case where a query described in a natural language is inputted so that a sentence consisting of words in the natural language is generated as the first content, a language model may be used as the first generative model 111. The language model is a model having learned, by machine learning, the arrangement of the components (such as words) of a sentence and the arrangement of sentences in text.

The first generative model 111 may be stored in the information processing apparatus 1, or may be stored in any other apparatus. In the latter case, the first generating section 101 instructs the other apparatus, which has the first generative model 111 stored therein, to generate the first content via the first generative model 111.

The second generating section 102 uses the first content generated by the first generating section 101, to cause the second generative model 112 to generate second content. The second generative model 112 is a generative model having been trained so as to generate content in accordance with an inputted query. As described above, the second generative model 112 is used for generating the second content.

The phrase “using the first content to cause the second generative model 112 to generate second content” here means that in causing the second generative model 112 to generate second content, the first content is used directly or indirectly. Examples of the direct use include inputting to the second generative model 112 the first content as it is, in combination with another information, or after modifying the first content, to cause the second generative model 112 to generate second content. Examples of the indirect use include inputting to the second generative model 112 the result of the analysis or compilation of the first content, information acquired with use of the first content, the information having been modified, or the result of the analysis or compilation of the information, to cause the second generative model 112 to generate second content.

Like the first generative model 111, the second generative model 112 is a generative model having been trained so as to generate content in accordance with an inputted query. As described above, the second generative model 112 is used for generating the second content.

As the second generative model 112, a model in accordance with the second content intended to be generated may be used. For example, in a case where a query described in a natural language is inputted so that a sentence consisting of words in the natural language is generated as the second content, a language model may be used as the second generative model 112.

The second generative model 112 may be stored in the information processing apparatus 1, or may be stored in any other apparatus. In the latter case, the second generating section 102 instructs the other apparatus, which has the second generative model 112 stored therein, to generate the second content via the second generative model 112.

The presenting section 103 presents the second content to a user. The manner in which the second content is presented is not particularly limited. For example, the presenting section 103 may present the second content by display output through displaying equipment, may present the second content by audio output through audio output equipment, or may present the second content by print output through a printing equipment. The equipment through which the second content is presented may be included in the information processing apparatus 1, or may be included in an apparatus external to the information processing apparatus 1.

As above, the information processing apparatus 1 includes: a first generating section 101 for causing the first generative model 111 to generate first content; a second generating section 102 for using the first content to cause the second generative model 112 to generate second content; and a presenting section 103 for presenting the second content to a user. With this configuration, two types of generative models which are the first generative model 111 and the second generative model 112 are used in combination for the generation of the second content to be presented to a user. It is therefore possible to present to a user high-quality content generated with use of generative models.

### Control Program

The functions of the information processing apparatus 1 can also be implemented via a program. A control program in accordance with the present example embodiment causes a computer to function as: a first generating means for causing a first generative model to generate first content; a second generating means for using the first content to cause a second generative model to generate second content; and a presenting means for presenting the second content to a user. Thus, the control program in accordance with the present example embodiment provides an example advantage of making it possible to present to a user high-quality content generated with use of generative models.

### Flow of Control Method

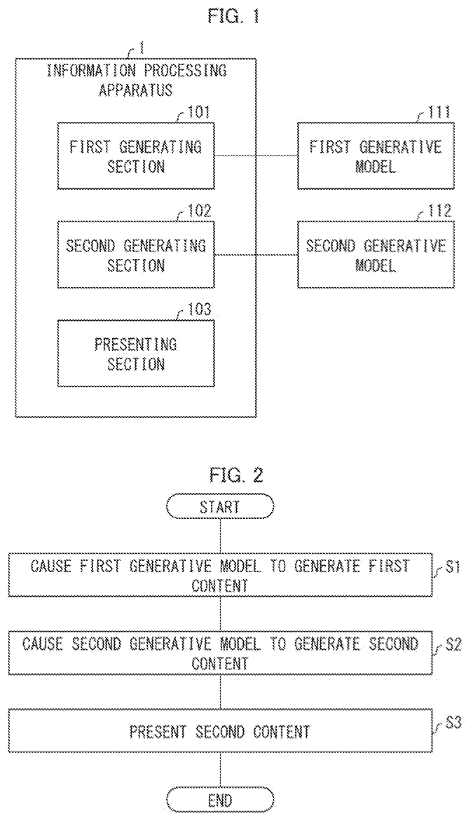

A flow of the control method will be described below with reference to FIG. 2. FIG. 2 is a flowchart illustrating a flow of the control method. It should be noted that each of the steps of this control method may be carried out by a processor included in the information processing apparatus 1, or may be carried out by a processor included in any other apparatus. Alternatively, the respective steps may be carried out by processors provided in different apparatuses.

In S1 (first generating process), at least one processor causes the first generative model to generate first content.

In S2 (second generating process), the at least one processor uses the first content generated in S1, to cause the second generative model to generate second content.

In S3 (presenting process), the at least one processor presents to a user the second content generated in S2.

As above, the control method in accordance with the present example embodiment includes: a first generating process of at least one processor causing a first generative model to generate first content; a second generating process of the at least one processor using the first content generated in the first generating process, to cause the second generative model to generate second content; and a presenting process of the at least one processor presenting to a user the second content generated in the second generating process. This provides an example advantage of making it possible to present to a user high-quality content generated with use of generative models.

### Configuration of Content Generation System

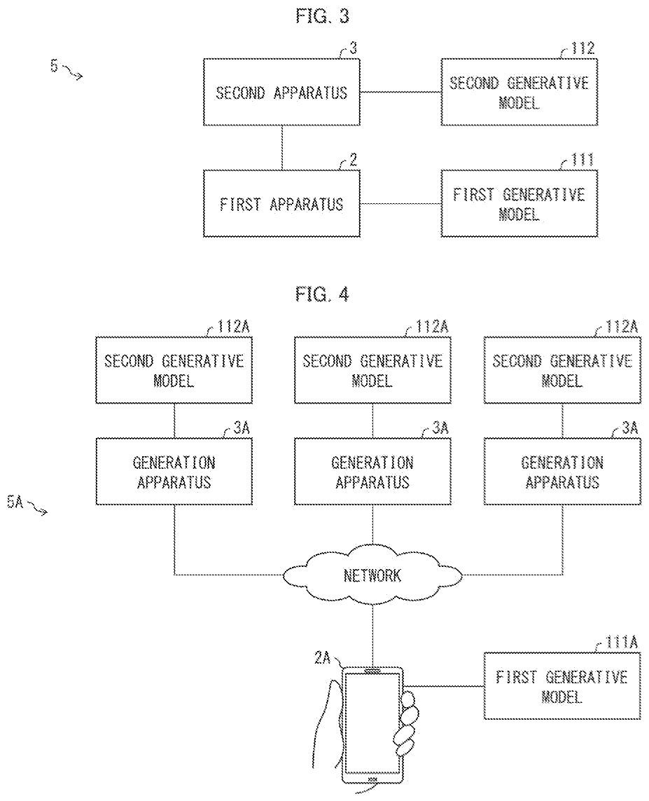

The configuration of a content generation system 5 will be described below with reference to FIG. 3. FIG. 3 is a block diagram illustrating the configuration of the content generation system 5. As illustrated, the content generation system 5 includes a first apparatus 2, a second apparatus 3, the first generative model 111, and the second generative model 112.

The first apparatus 2 inputs the first query to the first generative model 111 included in the first apparatus 2, to cause the first generative model 111 to generate first content. Further, the first apparatus 2 transmits to the second apparatus 3 the first content generated. Note that the first generative model 111 included in the first apparatus 2 means that the first generative model 111 is stored in storage accessible to the first apparatus 2. The above storage may be included in the first apparatus 2, or may be storage external to the first apparatus 2.

The second apparatus 3 uses the first content received from the first apparatus 2, to cause the second generative model 112 included in the second apparatus 3 to generate second content. Note that the second generative model 112 included in the second apparatus 3 means that the second generative model 112 is stored in storage accessible to the second apparatus 3. The above storage may be included in the second apparatus 3, or may be storage external to the second apparatus 3.

As above, the content generation system 5 in accordance with the present example embodiment includes: a first apparatus 2 including the first generative model 111; and a second apparatus 3 including the second generative model 112. The first apparatus 2 included in the content generation system 5 inputs the first query to the first generative model 111 to cause the first generative model 111 to generate first content, and also transmits to the second apparatus 3 the first content generated. The second apparatus 3 included in the content generation system 5 uses the first content received from the first apparatus 2, to cause the second generative model 112 to generate second content. Thus, the content generation system 5 provides an example advantage of making it possible to present to a user high-quality content generated with use of generative models.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicability of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle. These matters hold true for a third example embodiment which will be described later.

### Configuration of Content Generation System 5A

The configuration of a content generation system 5A will be described below with reference to FIG. 4. FIG. 4 is a representation of the outline of the content generation system 5A. The content generation system 5A includes the function of presenting, to a user of the content generation system 5A, content generated by a generative model.

As illustrated, the content generation system 5A includes a terminal 2A, a first generative model 111A, generation apparatuses 3A, and second generative models 112A. In the content generation system 5A, the terminal 2A is capable of communicating with the generation apparatuses 3A over any network.

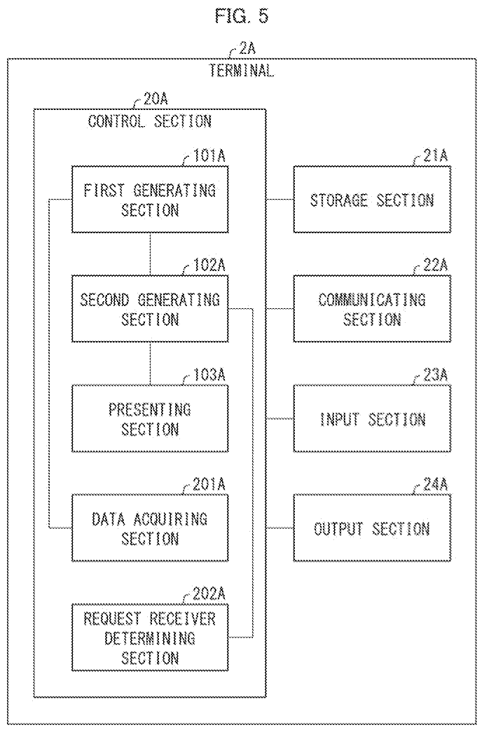

Although three pairs each being a pair of the generation apparatus 3A and the second generative model 112A are illustrated in FIG. 4, the content generation system 5A only needs to include at least a pair of the generation apparatus 3A and the second generative model 112A. Further, the content generation system 5A may include more than one terminal 2A. Illustrated in FIG. 4 is the example in which the terminal 2A is a smartphone. However, the terminal 2A only needs to be an apparatus capable of implementing the functions of the respective blocks illustrated in FIG. 5 (described later), and is not limited to a smartphone.

The terminal 2A inputs a first query to the first generative model 111A included in the terminal 2A, to cause the first generative model 111A to generate first content. The first query may be a query entered by a user of the terminal 2A to the terminal 2A. Further, the terminal 2A transmits to the generation apparatus 3A the first content generated. Which of the generation apparatuses 3A the first content is transmitted to is determined by the terminal 2A. This point will be described later in detail.

The generation apparatus 3A uses the first content received from the terminal 2A, to cause the second generative model 112A included in the generation apparatus 3A to generate second content. The generation apparatus 3A then transmits to the terminal 2A the second content generated. With this, the second content is presented to a user via the terminal 2A.

### Configuration of Terminal 2A

The configuration of a terminal 2A will be described below with reference to FIG. 5. FIG. 5 is a block diagram illustrating the configuration of the terminal 2A. As illustrated, the terminal 2A includes: a control section 20A for performing overall control of the sections of the terminal 2A; and a storage section 21A in which various kinds of data used by the terminal 2A are stored. The storage section 21A may have the first generative model 111A stored therein. In addition, the terminal 2A includes: a communicating section 22A via which the terminal 2A communicates with another apparatus; an input section 23A for accepting the input, to the terminal 2A, of various kinds of data; and an output section 24A via which the terminal 2A outputs various kinds of data. The functions of the output section 24A and the input section 23A may be implemented via a touch screen. The output section 24A may output voice. Further, as illustrated, the control section 20A includes a first generating section 101A, a second generating section 102A, a presenting section 103A, a data acquiring section 201A, and a request receiver determining section 202A. The functions of the respective sections included in the control section 20A can also be implemented by, for example, installing predetermined application software (control program) on the terminal 2A.

Like the first generating section 101 of the information processing apparatus 1, the first generating section 101A causes the first generative model 111A to generate first content. More specifically, the first generating section 101A inputs, to the first generative model 111A included in the terminal 2A, a first query entered by a user via the input section 23A, to cause the first generative model 111A to generate the first content.

Like the second generating section 102 of the information processing apparatus 1, the second generating section 102A uses the first content to cause the second generative model 112A to generate second content. More specifically, the second generating section 102A transmits, to the generation apparatus 3A via the communicating section 22A, the first content caused by the first generating section 101A to be generated, to cause the generation apparatus 3A to generate the second content with use of the first content. The second generating section 102A then acquires, from the generation apparatus 3A, the second content generated.

Like the presenting section 103 of the information processing apparatus 1, the presenting section 103A presents the second content to a user. For example, in a case where the second content is text data, the presenting section 103A may present to a user the second content, by causing the output section 24A to perform the display or voice output of the second content. Further, the presenting section 103A may present to a user the second content, by transmitting the second content to printing equipment via the communicating section 22A to output the second content in print.

The data acquiring section 201A acquires various kinds of data used in causing the first generative model 111A to generate the first content. For example, the data acquiring section 201A may acquire user-related information related to a user to whom the second content is to be presented. In this case, by inputting to the first generative model 111A the user-related information in addition to the first query, the first generating section 101A can generate the first content adapted for the user. The phrase “being adapted for the user” here means that at least part of the user-related information is reflected. Further, the user-related information may be related to the user themselves, may be related to the first query entered by the user, or may be related to both.

The request receiver determining section 202A determines which of the plurality of generation apparatuses 3A should be caused to generate the second content, i.e., the receiver of the request for content generation. A method for determining the request receiver may be determined as appropriate. As an example, the request receiver determining section 202A may determine the request receiver according to the first query entered by the user. As an example, in a case where the first query contains a medical-related keyword, the request receiver determining section 202A may determine that the generation apparatus 3A which generates medical-related second content with high accuracy should be the request receiver. As another example, in a case where the first query contains a mathematics-related keyword, the request receiver determining section 202A may determine that the generation apparatus 3A which is capable of generating the second content which contains a mathematical expression should be the request receiver. As still another example, the request receiver determining section 202A may determine, according to the language used for describing the first query, the generation apparatus 3A which should serve as the request receiver. Furthermore, the request receiver may be selected by a user. In this case, the request receiver determining section 202A determines the request receiver according to the user operation.

As above, the first generating section 101A causes the first generative model 111A included in the terminal 2A to generate first content, and the second generating section 102A transmits the first content to the generation apparatus 3A including the second generative model 112A, to cause the generation apparatus 3A to generate second content. Thus, the terminal 2A provides an example advantage of making it possible to generate second content by exploiting the characteristic of including the first generative model 111A in the terminal 2A and including the second generative model 112A in the generation apparatus 3A, in addition to the example advantage provided by the information processing apparatus 1.

For example, including the first generative model 111A in the terminal 2A makes it easy to generate the first content which has reflected therein the user-related information of the terminal 2A. Further, in a case of using the first generative model 111A, it is possible for the first generating section 101A to generate the first content without communicating with an apparatus external to the terminal 2A. Furthermore, in a case of using the first generative model 111A, it is possible for the first generating section 101A to generate the first content in a relatively short time.

Example characteristics of the second generative models 112A include the following: it is possible to generate the second content having a higher quality than the first content; it is possible to use information acquired from a data source inaccessible to the terminal 2A, to generate the second content; it is possible to generate the second content in a data form in which the first generative model 111A cannot generate content; etc.

Typically, when a language model has more explanatory variables, it is possible for the language model to generate an answer (content) of a higher quality, but correspondingly, higher computing power is required to generate the answer. Thus, in a case where the first generative model 111A and the second generative model 112A are the language models, the number of explanatory variables of the first generative model 111A is preferably smaller than that of the second generative model 112A. This enables the first generating section 101A to quickly generate the first content, even when the terminal 2A is inferior in computing power to the generation apparatuses 3A. The second generating section 102A can then transmit to the generation apparatus 3A the first content generated, to cause the generation apparatus 3A, which has excellent computing power, to generate the high-quality second content with use of the second generative model 112A.

### Configuration of Generation Apparatuses 3A

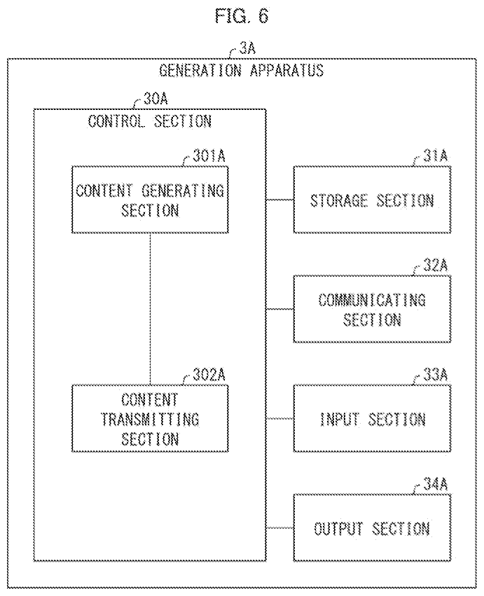

The configuration of the generation apparatuses 3A will be described below with reference to FIG. 6. FIG. 6 is a block diagram illustrating the configuration of the generation apparatuses 3A. As illustrated, the generation apparatuses 3A each include: a control section 30A for performing overall control of the sections of the generation apparatus 3A; and a storage section 31A in which various kinds of data used by the generation apparatus 3A are stored. In addition, the generation apparatuses 3A each include: a communicating section 32A via which the generation apparatus 3A communicates with another apparatus; an input section 33A for accepting the input, to the generation apparatus 3A, of various kinds of data; and an output section 34A via which the generation apparatus 3A outputs various kinds of data. Further, as illustrated, the control section 30A includes a content generating section 301A and a content transmitting section 302A.

The content generating section 301A causes the second generative model 112A to generate second content. More specifically, the content generating section 301A inputs to the second generative model 112A a second query received from the terminal 2A, to cause the second generative model 112A to generate second content.

The content transmitting section 302A transmits the second content generated by the content generating section 301A, to the terminal 2A via the communicating section 32A.

### Example Content Generation 1: Arrangement of Query

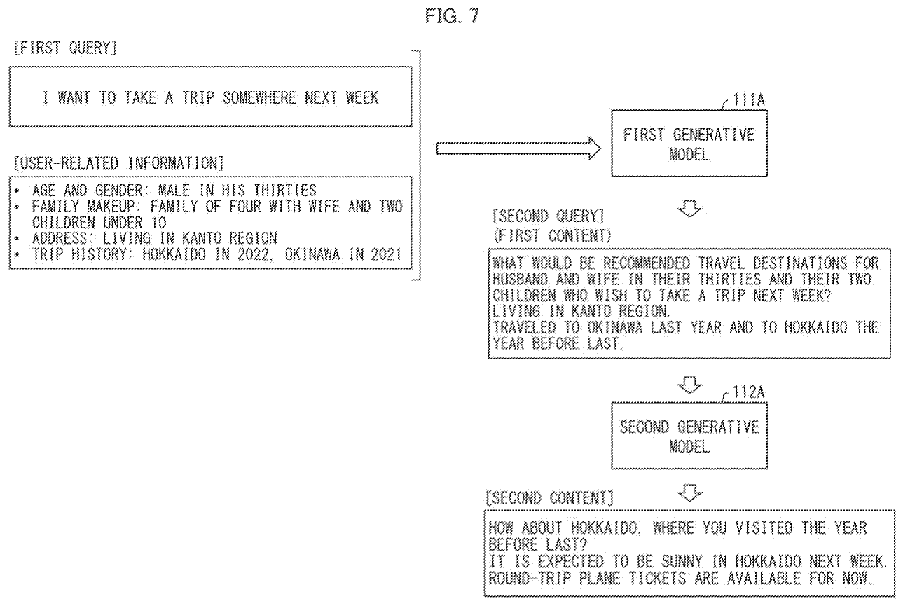

Example content generation in the content generation system 5A will be described below on the basis of FIG. 7. FIG. 7 is a representation of example content generation in the content generation system 5A. In the example of FIG. 7, the first query entered by a user of the terminal 2A to the terminal 2A is “I want to take a trip somewhere next week”. Further, the data acquiring section 201A acquires the age, gender, family makeup, address, and trip history of the user, as user-related information regarding the user who inputs the first query. In this manner, the user-related information may contain information indicating an attribute of a user, or may contain information indicating the activity history of a user.

The user-related information may be entered by a user in advance. Alternatively, the data acquiring section 201A may generate the user-related information from mails, schedules, and histories of posts on a social networking service (SNS) that are stored in the storage section 21A, the information on the position of the terminal 2A, and any other information. Automatically generating the user-related information can save a user from having to perform input. Further, by reflecting, in the user-related information, past events the user has forgotten and/or matters the user has not noticed, it is possible to generate the second content which has significance for the user.

The first generating section 101A inputs the first query and the user-related information to the first generative model 111A, to cause the first generative model 111A to generate first content. The first content generated here is a second query obtained by adapting the first query for the user. As an example, for the template “Generate a query by arranging the query of xxxx to suit the user of yyyy”, the first generating section 101A may substitute the first query for “xxxx” and substitute the user-related information for “yyyy” to generate a query, and input the generated query to the first generative model 111A to generate the second query. Note that not a query entered by a user but a query generated by the first generating section 101A on the basis of the query entered by a user can be referred to as the first query.

The first generating section 101A may use the first generative model 111A which has been trained in advance so as to generate, when the first query and the user-related information are inputted, a second query adapted for the user indicated in the user-related information. In this case, the first generating section 101A does not need to generate a query for generating a second query, but only needs to input to the first generative model 111A the first query and the user-related information as they are.

The first generating section 101A may generate the first content with use of the first generative model 111A which has been trained in advance so as to be capable of generating the first content adapted for a user. For example, in a case where a language model is used as the first generative model 111A, the language model may be retrained with use of labeled training data in which various queries and pieces of content judged by a user suitable for the various queries are associated with each other. By using such a language model as the first generative model 111A, it is possible for the first generating section 101A to generate content adapted for a user. In this case, it is possible to generate the first content adapted for a user without inputting the user-related information to the first generative model 111A.

When compared with the first query entered by the user, the second query illustrated in FIG. 7 has been arranged so as to have the user-related information reflected therein and also have clear information asking for the presentation of recommendations for a travel destination. The second generating section 102A uses this second query to cause the second generative model 112A to generate second content. Specifically, the second generating section 102A transmits the second query to the generation apparatus 3A, and instructs that second content be generated.

The content generating section 301A of the generation apparatus 3A receives the above instruction and the second query. Subsequently, the content generating section 301A inputs to the second generative model 112A the second query received, to cause the second generative model 112A to generate second content. The content transmitting section 302A then transmits to the terminal 2A the second content generated.

The second generating section 102A of the terminal 2A acquires the second content transmitted by the generation apparatus 3A, and the presenting section 103A presents to the user the second content acquired. The second content illustrated in FIG. 7 is text which constitutes an answer to the first query entered by the user. This text suggests travel destinations in accordance with the trip history of the user, and has content adapted for the user.

This text also refers to transportation to the travel destination. Since the second query indicates that the user lives in the Kanto region, it is possible for the second generative model 112A to generate an answer in consideration of transportation as well. Further, the content generating section 301A may check availabilities of transportation from the living place of the user to the destinations on travel dates during which the user wishes to have a trip, and may input to the second generative model 112A the results of the check as well. This makes it possible to generate the second content in consideration of the availabilities of transportation.

As above, the first generating section 101A may input the first query to the first generative model 111A, to cause the first generative model 111A to generate, as the first content, a second query adapted for a user. In this case, the second generating section 102A transmits the second query to the generation apparatus 3A, to cause the generation apparatus 3A to generate second content. This provides an example advantage of making it possible to present to a user second content adapted for the user, in addition to the example advantage provided by the information processing apparatus 1.

### Example Content Generation 2: Designation of Data Form

The first generating section 101A may input a first query to the first generative model 111A, to generate a second query instructing that content in accordance with the first query, the content being in a predetermined data form, be generated. Also in this case, the second generating section 102A transmits the second query to the generation apparatus 3A, to cause the generation apparatus 3A to generate second content. This provides an example advantage of making it possible to present, to a user, content in a predetermined data form, in addition to the example advantage provided by the information processing apparatus 1.

Any data form is used as the predetermined data form. For example, the predetermined data form may be image data or voice data. This makes it possible to present, to a user, image data or voice data as the second content. It is typically difficult to cause the first generative model 111A, which is included in the terminal 2A, to generate such data because of a problem such as the computing power of the terminal 2A. However, using the generation apparatus 3A, which has high computing power, makes it possible to generate such data. Further, by using the user-related information during the generation of the second query, it is possible to present the second content adapted for a user and in a predetermined data form.

As a specific example, assume that the first query entered by a user is “Summarize the details of today's conference in a comprehensible manner”, and the proceedings of the conference is entered as the user-related information. In this case, the first generating section 101A may input the first query and the user-related information to the first generative model 111A, to cause the first generative model 111A to generate a second query which instructs that image data indicating an answer to the first query be generated. As a result, a second query which is, for example, “Summarize the details of today's conference in a comprehensible manner. The output should be in the form of image data. The details of the conference are in the proceedings entered.” is generated. The content generating section 301A can then input this second query to the second generative model 112A, to generate an image in which the details of the conference are summarized in a comprehensible manner.

### Example Display Screen

In the content generation system 5A, the second content generated by the generation apparatus 3A is presented on the terminal 2A. This can cause a delay between the entry of a first query by a user to the terminal 2A and the presentation of second content to the user, due to factors such as communications environment, the data size of the second content, and the second content generation method. To address this, the terminal 2A may present third content to the user during a period up to a time at which the second content becomes available for presentation.

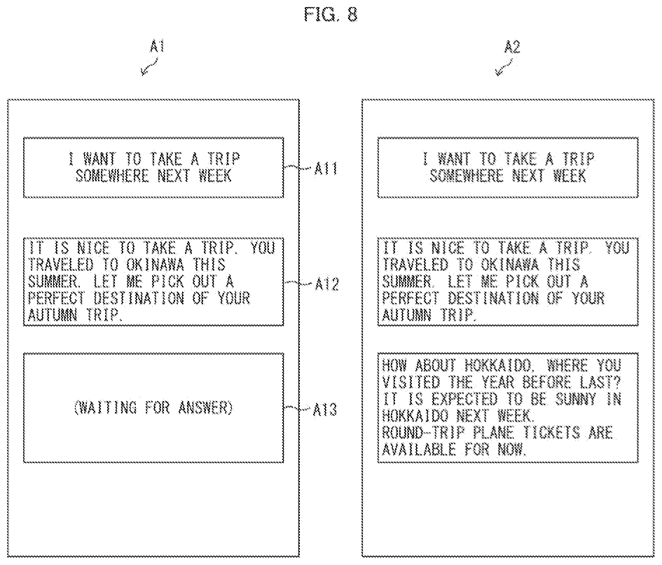

This will be described below on the basis of FIG. 8. FIG. 8 is a representation of an example display screen displayed by the terminal 2A. More specifically, illustrated in FIG. 8 are: a screen A1 displayed during the period from the entry of the first query by the user to a time at which the second content becomes available for presentation; and a screen A2 having the second content presented thereon.

In the screens A1 and A2, three display areas which are A11 to A13 are defined. Among the areas, A11 is a display area in which to display the first query entered by a user. In the display area A11 illustrated in FIG. 8, the first query the same as that in the example of FIG. 7 is displayed.

The display area A12 is a display area in which to display the third content described above. The third content is generated by inputting the first query to the first generative model 111A. That is, the first generating section 101A may cause the first generative model 111A to generate the third content, and the presenting section 103A may present the third content to the user during the period up to a time at which the second content becomes available for presentation.

Since the third content is generated via the first generative model 111A of the terminal 2A, it is possible to display the third content quickly after the first query is entered. Note that in generating the third content, the first generating section 101A may input to the first generative model 111A the first query as it is, or may input the first generative model 111A the first query having been modified. Further, the first generating section 101A may input to the first generative model 111A the user-related information in addition to the first query, to cause the first generative model 111A to generate the third content.

The display area A13 is a display area in which to display the second content. In the stage where the screen A1 is displayed, the second content is not available for presentation, the character string indicating a wait for an answer is displayed in the display area A13. In a case where it is not necessary to let user know the wait for an answer, such a display may be omitted.

During the display of the screen A1, the second generating section 102A transmits to the generation apparatus 3A the second query generated by the first generating section 101A, and acquires the second content transmitted by the generation apparatus 3A. Upon the acquisition of the second content, the presenting section 103A displays in the display area A13 the second content acquired. This results in the switch from the screen A1 to the screen A2. In the display area A13 of the screen A2, the second content is displayed. The presenting section 103A may end the presentation of the third content at the time of starting of the second content. In this case, it is not necessary to make the display areas A12 and A13 separated from each other.

As above, the first generating section 101A may input the first query to the first generative model 111A to cause the first generative model 111A to generate, as the first content, a second query adapted for a user, and also input the first query to the first generative model 111A to cause the first generative model 111A to generate third content. The presenting section 103A may then present the third content to a user during the period up to a time at which the second content becomes available for presentation. This provides an example advantage of making it possible to make a user feel less stressed while waiting for the presentation of the second content, in addition to the example advantage provided by the information processing apparatus 1.

### Flow of Processes

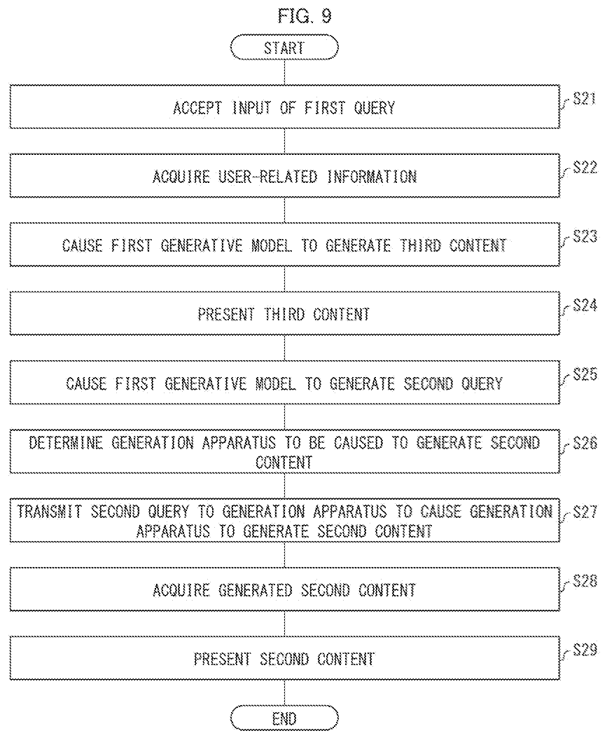

A flow of processes carried out by the terminal 2A will be described below on the basis of FIG. 9. FIG. 9 is a flowchart illustrating a flow of processes carried out by the terminal 2A. The flow of FIG. 9 includes the steps of the control method in accordance with the present example embodiment.

In S21, the first generating section 101A accepts the input of a first query. For example, the first generating section 101A may accept, as the first query, text entered by a user of the terminal 2A via the input section 23A.

In S22, the data acquiring section 201A acquires user-related information. The user-related information may be inputted by the user, or may be stored in advance in the storage section 21A or the like. Further, the data acquiring section 201A may acquire, as the user-related information, information related to the entered first query, from among various kinds of information related to the user-related information which are stored in advance in the storage section 21A or the like.

In S23, the first generating section 101A causes the first generative model 111A to generate third content. In this generation, the first generating section 101A may use the user-related information acquired in S22 to cause the first generative model 111A to generate third content. This makes it possible to generate the third content adapted for the user.

In S24, the presenting section 103A presents to the user the third content generated in S23. For example, by displaying a screen on which the first query and the third content are indicated, such as the screen A1 illustrated in FIG. 8, the presenting section 103A may present the query and content to the user.

In S25 (first generating process), the first generating section 101A causes the first generative model 111A to generate a second query (first content). In this generation, the first generating section 101A may use the user-related information acquired in S22 to cause the first generative model 111A to generate second query. This makes it possible to generate the second query adapted for the user.

In S26, the request receiver determining section 202A determines the generation apparatus 3A to be caused to generate second content. In a case where the content generation system 5A includes a single generation apparatus 3A, the process of S26 is omitted.

In S27 (second generating process), the second generating section 102A transmits the second query generated in S25 to the generation apparatus 3A determined in S26, to cause the generation apparatus 3A to generate second content. In other words, the second generating section 102A uses the second query, which is the first content, to cause the second generative model 112A of the generation apparatus 3A determined in S26 to generate second content. Note that the processes of S25 to S27 may be carried out prior to the processes of S23 and S24, or may be carried out in parallel with the processes of S23 and S24.

In S28, the second generating section 102A acquires the second content generated by the generation apparatus 3A. For example, the second generating section 102A acquires the second content transmitted by the generation apparatus 3A, in the communication conducted via the communicating section 22A.

In S29 (presenting process), the presenting section 103A presents to the user the second content acquired in S28. For example, the presenting section 103A may display a screen on which the first query, the second content, and the third content are indicated, such as the screen A2 illustrated in FIG. 8, to present the first query, the second content, and the third content to the user. Upon the end of the process of the S29, the processing of FIG. 9 ends.

### Example Content Generation 3: Use of Result of Analyzing Search Result

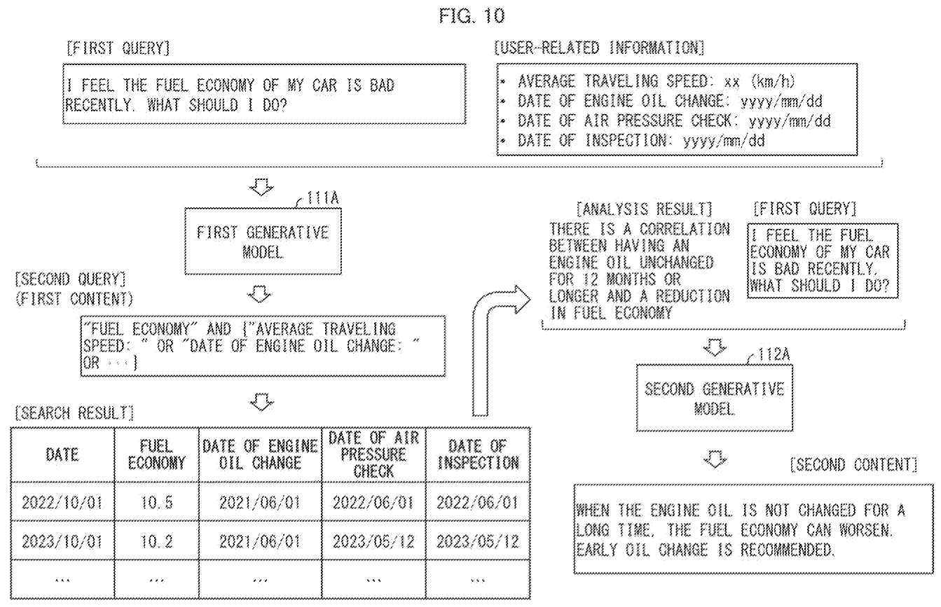

Another example content generation in the content generation system 5A will be described below on the basis of FIG. 10. FIG. 10 is a representation of another example content generation in the content generation system 5A. In the example of FIG. 10, the user of the terminal 2A enters a first query of “I feel the fuel economy of my car is bad recently. What should I do?” into the terminal 2A. Further, the data acquiring section 201A acquires, as the user-related information regarding the user who has inputted the first query, various kinds of information (average traveling speed, the last date of an engine oil change, etc.) regarding the vehicle possessed by the user.

The first generating section 101A inputs the first query and the user-related information to the first generative model 111A, to cause the first generative model 111A to generate first content. The first content generated in the example of FIG. 10 is the second query for searching for information related to the first query. That is, the second query in the example of FIG. 10 is not inputted to the second generative model 112A but is used for a search.

As an example, for the template “Generate a query for searching for information which is related to the query of xxxx and yyyy”, the first generating section 101A may substitute the first query for “xxxx” and substitute the user-related information for “yyyy” to generate a query, and input the generated query to the first generative model 111A to generate the second query. Note that not a query entered by a user but a query generated by the first generating section 101A on the basis of the query entered by a user can be referred to as the first query.

The first generating section 101A may use the first generative model 111A which has been trained so as to receive the first query and the user-related information and generate second query for a search. In this case, it is not necessary to generate a query to be used for generating the second query. Further, the first generating section 101A does not need to necessarily use the user-related information in generating the second query.

The second query illustrated in FIG. 7 indicates search criteria of containing the keyword “fuel economy”, which is contained in the first query entered by the user, and containing any of the keywords “average traveling speed”, “date of an engine oil change”, etc., which are contained in the user-related information. The second generating section 102A uses this second query to cause the second generative model 112A to generate second content. Specifically, the second generating section 102A transmits the first query and the second query to the generation apparatus 3A, and instructs that second content be generated.

The content generating section 301A of the generation apparatus 3A receives the instruction, the first query, and the second query. Subsequently, the content generating section 301A uses the second query received, to search for information related to the first query. In the search, any database is searched, and any algorithm is used. Further, the content generating section 301A may select a database and a search algorithm in accordance with the first query and second query received, and search the selected database with use of the selected search algorithm. For example, since the first query of FIG. 10 contains a keyword related to a vehicle, the content generating section 301A may search a database which has stored therein information related to vehicles, with use of an algorithm for searching the database.

In the example of FIG. 10, a table indicating the relationship among the fuel economy, the date of an engine oil change, etc. is outputted as the result of the search. The content generating section 301A uses such a search result, to perform an analysis to identify a factor which affects the fuel economy. Any algorithm is used in the analysis. For example, the content generating section 301A may perform a regression analysis to infer a factor which affects the fuel economy. In the example of FIG. 10, the analysis result is obtained which shows that there is a correlation between having an engine oil unchanged for 12 months or longer and a reduction in fuel economy.

The content generating section 301A inputs to the second generative model 112A the first query and information (e.g. text) indicating such an analysis result, to cause the second generative model 112A to generate second content. The content transmitting section 302A then transmits to the terminal 2A the second content generated.

The second generating section 102A of the terminal 2A acquires the second content transmitted by the generation apparatus 3A, and the presenting section 103A presents to the user the second content acquired. The second content illustrated in FIG. 10 is text which constitutes an answer to the first query entered by the user. This text is proposing an engine oil change in the light of the engine oil not having been changed by the user for a long time and the above analysis result, and therefore constitutes information which is adapted for the user.

Although the second content is generated by inputting to the second generative model 112A the result of analyzing a search result in the example of FIG. 10, the second content may be generated by inputting the search result to the second generative model 112A. For example, the content generating section 301A may use the second query to search for various kinds of text (e.g. text published in a web page or the like) related to the first query. The content generating section 301A may then input the first query and the detected text to the second generative model 112A, to cause the second generative model 112A to generate an answer to the first query in consideration of these pieces of text.

The search does not need to necessarily be performed by the generation apparatuses 3A. As an example, the terminal 2A may perform the search and notify the generation apparatus 3A of a search result. As another example, the search may be performed by an apparatus which is not either the terminal 2A or the generation apparatuses 3A, and a search result may be obtained from the apparatus. This applies also to the analysis of a search result, and the terminal 2A may perform the analysis, or another apparatus may be caused to perform the analysis.

As above, the first generating section 101A may input the first query to the first generative model 111A, to cause the first generative model 111A to generate, as the first content, a second query for searching for information related to the first query. The second generating section 102A may use the information obtained by the search performed with use of the second query, to cause the generation apparatus 3A to generate the second content. This provides an example advantage of making it possible to present the second content which has a search result reflected therein, in addition to the example advantage provided by the information processing apparatus 1.

### Third Example Embodiment

### Configuration of Content Generation System 5B

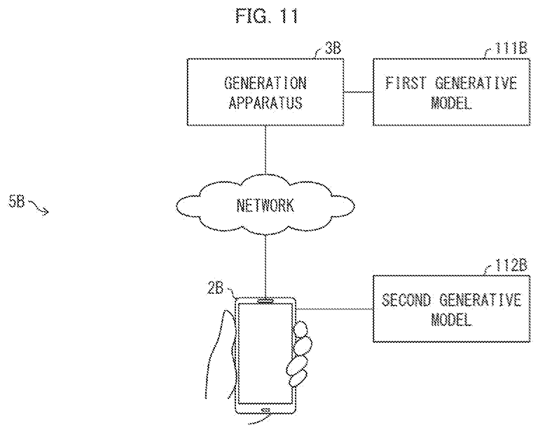

The configuration of a content generation system 5B will be described below with reference to FIG. 11. FIG. 11 is a representation of the outline of the content generation system 5B. Like the content generation systems 5 and 5A described above, the content generation system 5B has the function of presenting, to a user of the content generation system 5B, content generated by a generative model. Although only a pair of a generation apparatus 3B and a first generative model 111B is illustrated in FIG. 11, the content generation system 5B may include more than one pair of the generation apparatus 3B and the first generative model 111B.

The content generation system 5B differs from the content generation system 5A in that in the content generation system 5B, a terminal 2B includes a second generative model 112B and the generation apparatus 3B includes the first generative model 111B. Because the components of the terminal 2B and the generation apparatus 3B are the same as those of the terminal 2A and the generation apparatus 3A, the components of the terminal 2B and the generation apparatus 3B are referred to as the names illustrated in FIGS. 5 and 6 in the following description.

In the terminal 2B, a first generating section 101A inputs a first query to the first generative model 111B to cause the first generative model 111B to generate first content. As illustrated in FIG. 11, the first generative model 111B is included in the generation apparatus 3B. Thus, the first generating section 101A transmits the first query to the generation apparatus 3B via a communicating section 22A, to cause the generation apparatus 3B to generate first content with use of the first query. The first generating section 101A then acquires from the generation apparatus 3B, the first content generated.

In the terminal 2B, a second generating section 102A inputs, to the second generative model 112B, the first content acquired by the first generating section 101A, to cause the second generative model 112B to generate second content adapted for the user. This provides an example advantage of making it possible to present second content adapted for a user, in addition to the example advantage provided by the information processing apparatus 1.

### Example Content Generation 4: Arrangement of First Content

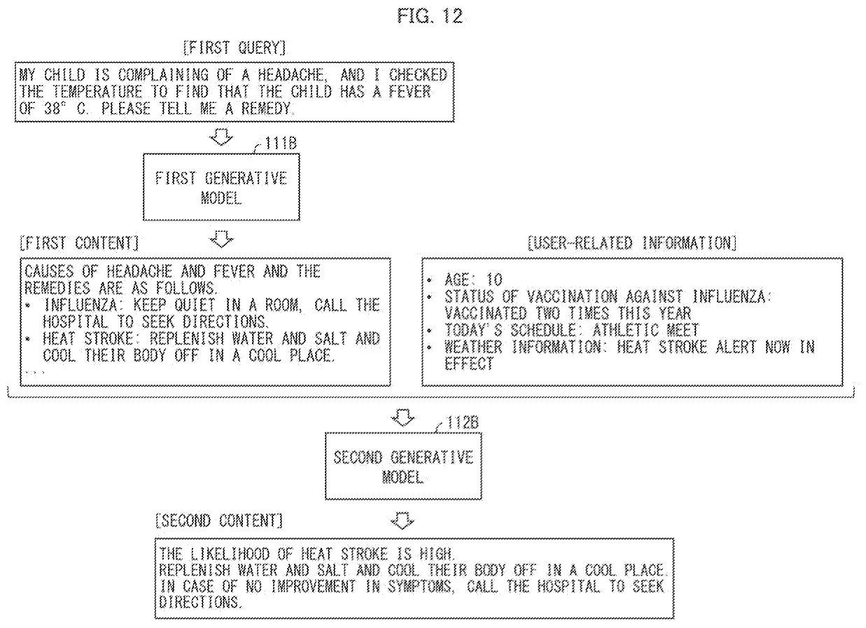

Example content generation in the content generation system 5B will be described below on the basis of FIG. 12. FIG. 12 is a representation of example content generation in the content generation system 5B. In the example of FIG. 12, the user of the terminal 2B enters a first query of “My child is complaining of a headache, and I checked the temperature to find that the child has a fever of 38° C. Please tell me a remedy” into the terminal 2B. In this manner, the content generation system 5B can be used for health care purposes.

The first generating section 101A of the terminal 2B transmits to the generation apparatus 3B the first query entered. Upon the reception of the first query, the content generating section 301A of the generation apparatus 3B inputs to the first generative model 111B the first query received, to cause the first generative model 111B to generate first content. The content transmitting section 302A then transmits to the terminal 2B the first content generated.

In this context, the first generative model 111B is included in the generation apparatus 3B, which can be shared by a plurality of users. Thus, the accuracy of the first generative model 111B is more likely to increase than is the accuracy of the second generative model 112B included in the terminal 2B, which is individually used by the individual user. This makes it possible to generate the first content of a higher quality than in a case of using the second generative model 112B. It should be noted that the first content generated with use of the first generative model 111B does not constitute information adapted for the user of the terminal 2B, into which the first query is inputted.

For example, the first content illustrated in FIG. 12 indicates remedies for various possible causes of symptoms which are a headache and a fever. However, the first content is generated without considering the user who enters the first query, and only has various causes listed therein. Thus, some users can feel that it is difficult to find, from the first content, information they require.

To address this, the second generating section 102A arranges the first content such that the first content suits the user. Specifically, the second generating section 102A inputs the first content to the second generative model 112B, to cause the second generative model 112B to generate second content adapted for the user.

Examples of a method for generating second content adapted for a user include a method of inputting to the second generative model 112B user-related information regarding the user together with the first content. FIG. 12 is a representation of an example to which this method is applied. Specifically, as the user-related information regarding the user who inputs the first query, the age of the user's child, the status of vaccination against influenza, a schedule, and weather information are inputted to the second generative model 112B. This makes it possible to generate, from the first content, second content adapted for a user.

As an example, for the template “From the text of xxxx, extract a portion which is fit for the user of yyyy”, the second generating section 102A may substitute the first content for “xxxx” and substitute the user-related information for “yyyy” to generate a query. The second generating section 102A may then input the generated query to the second generative model 112B, to cause the second generative model 112B to generate second content. This makes it possible to present the second content which constitutes information narrowed down to be fit for the user-related information, as illustrated in FIG. 12.

The method for generating the second content adapted for a user is not limited to the above example. For example, it is also possible for the second generating section 102A to generate second content adapted for the user with use of the second generative model 112B having been trained so as to generate, from the first content, second content adapted for a user.

### Flow of Processes

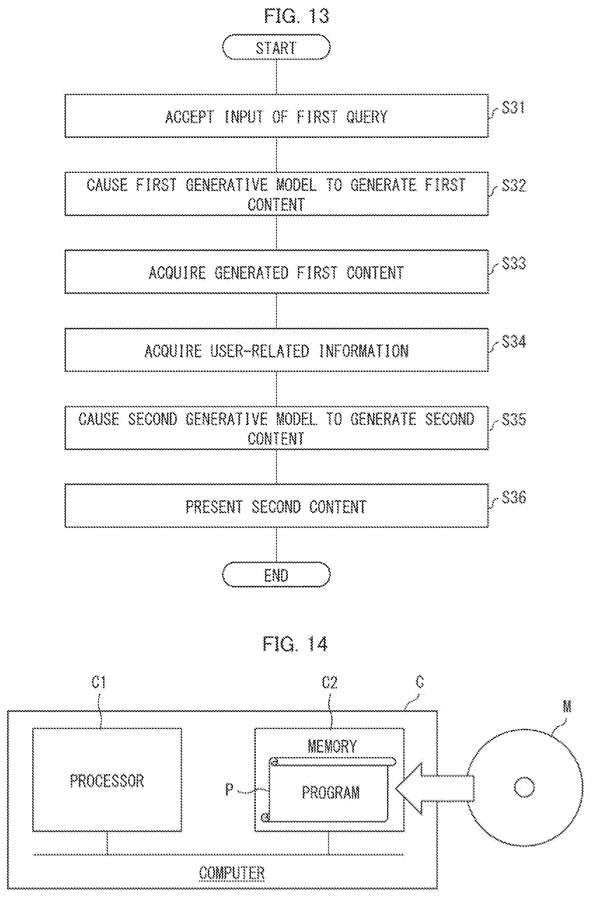

A flow of processes carried out by the terminal 2B will be described below on the basis of FIG. 13. FIG. 13 is a flowchart illustrating a flow of processes carried out by the terminal 2B. The flow of FIG. 13 includes the steps of the control method in accordance with the present example embodiment.

In S31, the first generating section 101A accepts the input of a first query. Subsequently, in S32 (first generating process), the first generating section 101A causes the first generative model 111B to generate first content. Specifically, the first generating section 101A transmits the first query acquired in S31 to the generation apparatus 3B, to cause the first generative model 111B to generate first content. Thereafter, in S33, the first generating section 101A acquires the first content generated by the generation apparatus 3B. Note that the request receiver determining section 202A may carry out the process of determining the generation apparatus 3B to be caused to generate the first content, between S31 and S32.

In S34, the data acquiring section 201A acquires user-related information. The process of S34 only needs to be carried out before S35. For example, the process of S34 may be carried out before S31 to S33, or may be carried out in parallel with the processes of S31 to S33.

In S35 (second generating process), the second generating section 102A uses the first content acquired in S33, to cause the second generative model 112B to generate second content. In this generation, the second generating section 102A may use the user-related information acquired in S34, to cause the second generative model 112B to generate second content. This makes it possible to generate the second content adapted for the user.

In S36 (presenting process), the presenting section 103A presents to the user the second content generated in S35. Upon the end of the process of the S36, the processing of FIG. 13 ends.

### Variation

The agent for each of the processes described in the above example embodiments is any performer, and is not limited to the above examples. That is, the functions of the information processing apparatus 1, the first apparatus 2, the second apparatus 3, the terminals 2A and 2B, and the generation apparatuses 3A and 3B can be implemented by a plurality of apparatuses (which can also be referred to as processors) capable of communicating with each other. For example, the processes described in the flowcharts of FIGS. 2, 9, and 13 can be shared and carried out by the plurality of processors. That is, the processes in the above example embodiments may be carried out by a single processor, or may be carried out by a plurality of processors.

### Software Implementation Example

Some or all of the functions of each of the information processing apparatus 1, the first apparatus 2, the second apparatus 3, the terminals 2A and 2B, and the generation apparatuses 3A and 3B (hereinafter, “each apparatus above”) may be implemented by hardware such as an integrated circuit (IC chip), or may be implemented by software.

In the latter case, each apparatus above is provided by, for example, a computer that executes instructions of a program that is software implementing the foregoing functions. An example (hereinafter, computer C) of such a computer is illustrated in FIG. 14. FIG. 14 is a block diagram illustrating a hardware configuration of the computer C which functions as each apparatus above.

The computer C includes at least one processor C1 and at least one memory C2. The memory C2 has recorded thereon a program (control program) P for causing the computer C to operate as each apparatus above. The processor C1 of the computer C retrieves the program P from the memory C2 and executes the program P, so that the functions of each apparatus above are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can also obtain the program P via such a transmission medium.

### Additional Remark

The whole or part of the example embodiments disclosed above can be described as, but not limited to, the following supplementary notes.

### Supplementary Note A1

An information processing apparatus, including: a first generating means for causing a first generative model to generate first content; a second generating means for using the first content to cause a second generative model to generate second content; and a presenting means for presenting the second content to a user.

### Supplementary Note A2

The information processing apparatus described in supplementary note A1, in which the first generating means is configured to cause the first generative model which is included in the information processing apparatus to generate the first content, and the second generating means is configured to transmit the first content to a generation apparatus which includes the second generative model, to cause the generation apparatus to generate the second content.

### Supplementary Note A3

The information processing apparatus described in supplementary note A2, in which the first generating means is configured to input a first query to the first generative model, to cause the first generative model to generate, as the first content, a second query adapted for the user, and the second generating means is configured to transmit the second query to the generation apparatus, to cause the generation apparatus to generate the second content.

### Supplementary Note A4

The information processing apparatus described in supplementary note A2 or A3, in which the first generating means is configured to input a first query to the first generative model, to generate a second query instructing that content in accordance with the first query, the content being in a predetermined data form, be generated, and the second generating means is configured to transmit the second query to the generation apparatus, to cause the generation apparatus to generate the second content.

### Supplementary Note A5

The information processing apparatus described in any one of supplementary notes A2 to A4, in which the first generating means is configured to input a first query to the first generative model to cause the first generative model to generate, as the first content, a second query adapted for the user, and also input the first query to the first generative model to cause the first generative model to generate third content, and the presenting means is configured to present the third content to the user during a period up to a time at which the second content becomes available for presentation.

### Supplementary Note A6

The information processing apparatus described in supplementary note A2, in which the first generating means is configured to input a first query to the first generative model to cause the first generative model to generate, as the first content, a second query for performing a search for information related to the first query, and the second generating means is configured to use the information obtained through the search performed with use of the second query, to cause the generation apparatus to generate the second content.

### Supplementary Note A7

The information processing apparatus described in supplementary note A1, in which the first generating means is configured to input a first query to the first generative model to generate the first content, and the second generating means is configured to input the first content to the second generative model, to cause the second generative model to generate the second content adapted for the user.

### Supplementary Note A8

A content generation system, including: a first apparatus including a first generative model; and a second apparatus including a second generative model, the first apparatus being configured to input a first query to the first generative model to cause the first generative model to generate first content, and also transmit to the second apparatus the first content generated, the second apparatus being configured to use the first content received from the first apparatus, to cause the second generative model to generate second content.

### Supplementary Note B1

A control method, including: a first generating process of at least one processor causing a first generative model to generate first content; a second generating process of the at least one processor using the first content to cause a second generative model to generate second content; and a presenting process of the at least one processor presenting the second content to a user.

### Supplementary Note B2

The control method described in supplementary note B1, in which in the first generating process, the at least one processor causes the first generative model which is included in the information processing apparatus to generate the first content, and in the second generating process, the at least one processor transmits the first content to a generation apparatus which includes the second generative model, to cause the generation apparatus to generate the second content.

### Supplementary Note B3

The control method described in supplementary note B2, in which in the first generating process, the at least one processor inputs a first query to the first generative model, to cause the first generative model to generate, as the first content, a second query adapted for the user, and in the second generating process, the at least one processor transmits the second query to the generation apparatus, to cause the generation apparatus to generate the second content.

### Supplementary Note B4

The control method described in supplementary note B2 or B3, in which in the first generating process, the at least one processor inputs a first query to the first generative model, to generate a second query instructing that content in accordance with the first query, the content being in a predetermined data form, be generated; and in the second generating process, the at least one processor transmits the second query to the generation apparatus, to cause the generation apparatus to generate the second content.

### Supplementary Note B5

The control method described in any one of supplementary notes B2 to B4, in which in the first generating process, the at least one processor inputs a first query to the first generative model to cause the first generative model to generate, as the first content, a second query adapted for the user, and also inputs the first query to the first generative model to cause the first generative model to generate third content; and in the presenting process, the at least one processor presents the third content to the user during a period up to a time at which the second content becomes available for presentation.

### Supplementary Note B6

The control method described in supplementary note B2, in which in the first generating process, the at least one processor inputs a first query to the first generative model to cause the first generative model to generate, as the first content, a second query for performing a search for information related to the first query, and in the second generating process, the at least one processor uses the information obtained through the search performed with use of the second query, to cause the generation apparatus to generate the second content.

### Supplementary Note B7

The control method described in supplementary note B1, in which in the first generating process, the at least one processor inputs a first query to the first generative model to generate the first content, and in the second generating process, the at least one processor inputs the first content to the second generative model, to cause the second generative model to generate the second content adapted for the user.

### Supplementary Note C1

A control program for causing a computer to function as: a first generating means for causing a first generative model to generate first content; a second generating means for using the first content to cause a second generative model to generate second content; and a presenting means for presenting the second content to a user.

### Supplementary note C2

The control program described in supplementary note C1 in which the first generating means is configured to cause the first generative model which is included in the computer to generate the first content, and the second generating means is configured to transmit the first content to a generation apparatus which includes the second generative model, to cause the generation apparatus to generate the second content.

### Supplementary Note C3

The control program described in supplementary note C2, in which the first generating means is configured to input a first query to the first generative model, to cause the first generative model to generate, as the first content, a second query adapted for the user, and the second generating means is configured to transmit the second query to the generation apparatus, to cause the generation apparatus to generate the second content.

### Supplementary Note C4

The control program described in supplementary note C2 or C3, in which the first generating means is configured to input a first query to the first generative model, to generate a second query instructing that content in accordance with the first query, the content being in a predetermined data form, be generated, and the second generating means is configured to transmit the second query to the generation apparatus, to cause the generation apparatus to generate the second content.

### Supplementary Note C5

The control program described in any one of supplementary notes C2 to C4, in which the first generating means is configured to input a first query to the first generative model to cause the first generative model to generate, as the first content, a second query adapted for the user, and also input the first query to the first generative model to cause the first generative model to generate third content, and the presenting means is configured to present the third content to the user during a period up to a time at which the second content becomes available for presentation.

### Supplementary Note C6

The control program described in supplementary note C2, in which the first generating means is configured to input a first query to the first generative model to cause the first generative model to generate, as the first content, a second query for performing a search for information related to the first query, and the second generating means is configured to use the information obtained through the search performed with use of the second query, to cause the generation apparatus to generate the second content.

### Supplementary Note C7

The control program described in supplementary note C1, in which the first generating means is configured to input a first query to the first generative model to generate the first content, and the second generating means is configured to input the first content to the second generative model, to cause the second generative model to generate the second content adapted for the user.

### Supplementary Note D1

An information processing apparatus, including at least one processor, the at least one processor carrying out: a first generating process of causing a first generative model to generate first content; a second generating process of using the first content to cause a second generative model to generate second content; and a presenting process of presenting the second content to a user.

### Supplementary Note D2

The information processing apparatus described in supplementary note D1, in which in the first generating process, the at least one processor causes the first generative model which is included in the information processing apparatus to generate the first content, and in the second generating process, the at least one processor transmits the first content to a generation apparatus which includes the second generative model, to cause the generation apparatus to generate the second content.

### Supplementary Note D3

The information processing apparatus described in supplementary note D2, in which in the first generating process, the at least one processor inputs a first query to the first generative model, to cause the first generative model to generate, as the first content, a second query adapted for the user, and in the second generating process, the at least one processor transmits the second query to the generation apparatus, to cause the generation apparatus to generate the second content.

### Supplementary Note D4

The information processing apparatus described in supplementary note D2 or D3, in which in the first generating process, the at least one processor inputs a first query to the first generative model, to generate a second query instructing that content in accordance with the first query, the content being in a predetermined data form, be generated; and in the second generating process, the at least one processor transmits the second query to the generation apparatus, to cause the generation apparatus to generate the second content.

### Supplementary Note D5

The information processing apparatus described in any one of supplementary notes D2 to D4, in which in the first generating process, the at least one processor inputs a first query to the first generative model to cause the first generative model to generate, as the first content, a second query adapted for the user, and also inputs the first query to the first generative model to cause the first generative model to generate third content; and in the presenting process, the at least one processor presents the third content to the user during a period up to a time at which the second content becomes available for presentation.

### Supplementary Note D6

The information processing apparatus described in supplementary note D2, in which in the first generating process, the at least one processor inputs a first query to the first generative model to cause the first generative model to generate, as the first content, a second query for performing a search for information related to the first query, and in the second generating process, the at least one processor uses the information obtained through the search performed with use of the second query, to cause the generation apparatus to generate the second content.

### Supplementary Note D7

The information processing apparatus described in supplementary note D1, in which in the first generating process, the at least one processor inputs a first query to the first generative model to generate the first content, and in the second generating process, the at least one processor inputs the first content to the second generative model, to cause the second generative model to generate the second content adapted for the user.

The information processing apparatus may further include a memory. The memory may have stored therein a control program for causing the at least one processor to carry out each of the above processes.

### Supplementary Note E1

A non-transitory recording medium having recorded thereon a control program for causing a computer to carry out: a first generating process of causing a first generative model to generate first content; a second generating process of using the first content to cause a second generative model to generate second content; and a presenting process of presenting the second content to a user.

### REFERENCE SIGNS LIST

1: Information processing apparatus
101: First generating section (first generating means)
102: Second generating section (second generating means)
103: Presenting section (presenting means)
111: First generative model
112: Second generative model
2: First apparatus
3: Second apparatus
5: Content generation system
2A: Terminal (information processing apparatus, first apparatus)
101A: First generating section (first generating means)
102A: Second generating section (second generating means)
103A: Presenting section (presenting means)
111A: First generative model
112A: Second generative model
3A: Generation apparatus (second apparatus)
5A: Content generation system
2B: Terminal (information processing apparatus, first apparatus)
3B: Generation apparatus (second apparatus)
111B: First generative model
112B: Second generative model
5B: Content generation system

1. An information processing apparatus, comprising
at least one processor, the at least one processor carrying out:
a first generating process of causing a first generative model to generate first content;
a second generating process of using the first content to cause a second generative model to generate second content; and
a presenting process of presenting the second content to a user.

2. The information processing apparatus according to claim 1, wherein
in the first generating process, the at least one processor causes the first generative model which is included in the information processing apparatus to generate the first content, and
in the second generating process, the at least one processor transmits the first content to a generation apparatus which includes the second generative model, to cause the generation apparatus to generate the second content.

3. The information processing apparatus according to claim 2, wherein
in the first generating process, the at least one processor inputs a first query to the first generative model, to cause the first generative model to generate, as the first content, a second query adapted for the user, and
in the second generating process, the at least one processor transmits the second query to the generation apparatus, to cause the generation apparatus to generate the second content.

4. The information processing apparatus according to claim 2, wherein
in the first generating process, the at least one processor inputs a first query to the first generative model, to generate a second query instructing that content in accordance with the first query, the content being in a predetermined data form, be generated, and
in the second generating process, the at least one processor transmits the second query to the generation apparatus, to cause the generation apparatus to generate the second content.

5. The information processing apparatus according to claim 2, wherein
in the first generating process, the at least one processor inputs a first query to the first generative model to cause the first generative model to generate, as the first content, a second query adapted for the user, and also inputs the first query to the first generative model to cause the first generative model to generate third content, and
in the presenting process, the at least one processor presents the third content to the user during a period up to a time at which the second content becomes available for presentation.

6. The information processing apparatus according to claim 2, wherein
in the first generating process, the at least one processor inputs a first query to the first generative model to cause the first generative model to generate, as the first content, a second query for performing a search for information related to the first query, and
in the second generating process, the at least one processor uses the information obtained through the search performed with use of the second query, to cause the generation apparatus to generate the second content.

7. The information processing apparatus according to claim 1, wherein
in the first generating process, the at least one processor inputs a first query to the first generative model to generate the first content, and
in the second generating process, the at least one processor inputs the first content to the second generative model, to cause the second generative model to generate the second content adapted for the user.

8. A content generation system, comprising:
a first apparatus including a first generative model; and
a second apparatus including a second generative model,
the first apparatus being configured to input a first query to the first generative model to cause the first generative model to generate first content, and also transmit to the second apparatus the first content generated,
the second apparatus being configured to use the first content received from the first apparatus, to cause the second generative model to generate second content.

9. A control method, comprising:
at least one processor causing a first generative model to generate first content;
the at least one processor using the first content to cause a second generative model to generate second content; and
the at least one processor presenting the second content to a user.
